(19) United States
(12) Patent Application Publication
(10) Pub. No.: US 2016/0298484 A1
(43) Pub. Date: Oct. 13, 2016

(54) A METHOD FOR PROVIDING COOLANT TO A MOVABLE AIRFOIL

(71) Applicant: UNITED TECHNOLOGIES CORPORATION, Hartford, CT (US)

(72) Inventors: John D. Teixeira, Palm City, FL (US); Thomas N. Slavens, Vernon, CT (US); Raymond Surace, Newington, CT (US)

(21) Appl. No.: 15/036,856

(22) PCT Filed: Nov. 3, 2014
(86) PCT No.: PCT/US2014/063647

§ 371 Date: May 16, 2016

Related U.S. Application Data
(60) Provisional application No. 61/908,387, filed on Nov. 25, 2013.

(51) Int. Cl. F01D 17/16; F01D 25/12; F04D 29/056; F01D 9/04; F04D 29/56; F04D 29/58

(52) U.S. Cl. CPC F01D 17/162; F04D 29/563; F04D 29/582; F04D 29/056; F01D 9/041; F01D 25/12; F05D 2220/32; F05D 2240/50; F05D 2260/20

(57) ABSTRACT

A gas turbine engine with an adjustable vane includes a platform with a hole and an aperture. A vane is supported for rotation relative to the platform by a trunion that is received in the hole. The vane has an opening that is laterally spaced from the trunion and is in alignment with the aperture. The vane includes an airfoil with a cooling passage in fluid communication with the opening.

### CROSS-REFERENCE TO RELATED APPLICATIONS

This application claims priority to U.S. Provisional Application No. 61/908,387, which was filed on Nov. 25, 2013 and is incorporated herein by reference.

### STATEMENT REGARDING FEDERALLY SPONSORED RESEARCH OR DEVELOPMENT

This invention was made with government support with the United States Navy under Contract No.: N00014-09-D-0821-0006. The government therefore has certain rights in this invention.

### BACKGROUND

This disclosure relates to a gas turbine engine with an adjustable vane. More particularly, the disclosure relates to an adjustable vane sealing arrangement.

A gas turbine engine uses a compressor section that compresses air. The compressed air is provided to a combustor section where the compressed air and fuel is mixed and burned. The hot combustion gases pass through a turbine section to provide work that may be used for thrust or driving another system component.

In general, it is often the case that the temperature of the gases passing through the flow path of a turbine stage may exceed a maximum allowable temperature of the turbine vane material, and therefore it is necessary to provide a continuous supply of cooling air to the interior of the airfoil in order to limit its maximum temperature. A turbine section typically has one or more fixed stages and one or more rotatable stages. A typical cooling scheme is to feed the cooling air though openings in fixed stator vanes. Such openings are situated directly over the attached airfoil, such that the cooling air enters directly into passages internal to the airfoil. Inner and outer diameter platforms serve to constrain the stator vane relative to the static structure of the turbine section, and additionally serve to define the inner and outer diameter flow path boundaries.

In certain designs, variable stator vanes may be used in the fixed stage where the airfoil portion of the vanes is rotatable about a radial axis. In one embodiment, such turbine vanes include an airfoil and a cylindrical trunnion that connects the airfoil to a support structure, such as inner and outer cases, via a set of bushings or bearings. Cooling air may be provided to the airfoil through an aperture in the trunion. There is typically a gap between the moveable airfoil section and the support structure that permits the airfoil section to rotate freely without interference or binding with the support structure. One or more actuators selectively rotates the airfoil section of the variable vanes about the trunions between desired positions.

### SUMMARY

In one exemplary embodiment, a gas turbine engine with an adjustable vane includes a platform with a hole and an aperture. A vane is supported for rotation relative to the platform by a trunion that is received in the hole. The vane has an opening that is laterally spaced from the trunion and is in alignment with the aperture. The vane includes an airfoil with a cooling passage in fluid communication with the opening.

In a further embodiment of the above, the platforms include an outer platform having a boss. The boss circumscribes the aperture.

In a further embodiment of any of the above, the outer platform includes a groove that is opposite the boss and adjacent to the vane. A seal is provided in the groove and is engageable with the vane.

In a further embodiment of any of the above, a cooling source is in fluid communication with the outer platform. A passageway extends through the boss to the groove and is configured to supply fluid from the cooling source to the seal to urge the seal into engagement with the vane.

In a further embodiment of any of the above, the aperture is larger than the opening. The seal circumscribes the aperture.

In a further embodiment of any of the above, the vane is moveable between fully opened and closed positions. The vane opening remains within the seal boundary in the fully opened and closed positions.

In a further embodiment of any of the above, the opening is an entrance. The cooling passage includes an exit opposite the entrance. The platform includes an inner platform that has a recess that is in fluid communication with the exit.

In a further embodiment of any of the above, the inner platform includes a groove that is opposite the vane. A seal is provided in the groove and is engageable with the vane.

In a further embodiment of any of the above, a cooling source is in fluid communication with the outer platform. A passageway extends through the boss to the groove and is configured to supply fluid from the cooling source to the seal to urge the seal into engagement with the vane.

In a further embodiment of any of the above, the aperture is larger than the opening. The seal circumscribes the aperture. The vane is moveable between fully opened and closed positions. The vane opening remains within the seal boundary in the fully opened and closed positions.

In a further embodiment of any of the above, the vane is arranged within the turbine section.

In a further embodiment of any of the above, a circumferential array of fixed and adjustable vanes is included.

In another exemplary embodiment, an adjustable vane for a gas turbine engine includes an airfoil that is arranged between opposing trunions extending from opposing sealing faces. An opening in one of the sealing faces is laterally spaced from one of the trunions. The airfoil has a cooling passage that is in fluid communication with the opening.

In a further embodiment of the above, an opening is provided on each of the sealing faces.

In a further embodiment of any of the above, the trunions are not in fluid communication with the cooling passage.

In a further embodiment of any of the above, bushings or bearings are supported on each of the trunions.

In one exemplary embodiment, a method of cooling an adjustable vane for a gas turbine engine includes supporting a vane for rotation relative to a platform about a trunion, and energizing a seal provided between the platforms and the vane to seal a gap between the platforms and the vane.

In a further embodiment of any of the above, the method includes the step of supplying cooling fluid to the vane from an area adjacent to the trunion.

In a further embodiment of any of the above, the platform includes an inner platform and an outer platform. The method includes the step of energizing a seal that is provided between at least one of the outer and inner platforms and the vane and engaging the vane with the seal.

In a further embodiment of any of the above, the supplying step includes providing a cooling fluid to the interior of the vane.

### BRIEF DESCRIPTION OF THE DRAWINGS

The disclosure can be further understood by reference to the following detailed description when considered in connection with the accompanying drawings wherein:

FIG. 1 is a highly schematic view of an example turbojet engine.

FIG. 2 is a perspective view of a portion of a variable stage.

FIGS. 3A and 3B are top elevational views of the variable stator vane in the fully closed and fully opened positions, respectively.

FIG. 4 is a perspective view of a portion of a variable stage having fixed vanes with the variable vane removed.

FIG. 5 is an elevational view of the variable stator vane.

FIG. 6 is a cross-sectional view through the variable stator vane illustrating a sealing configuration.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

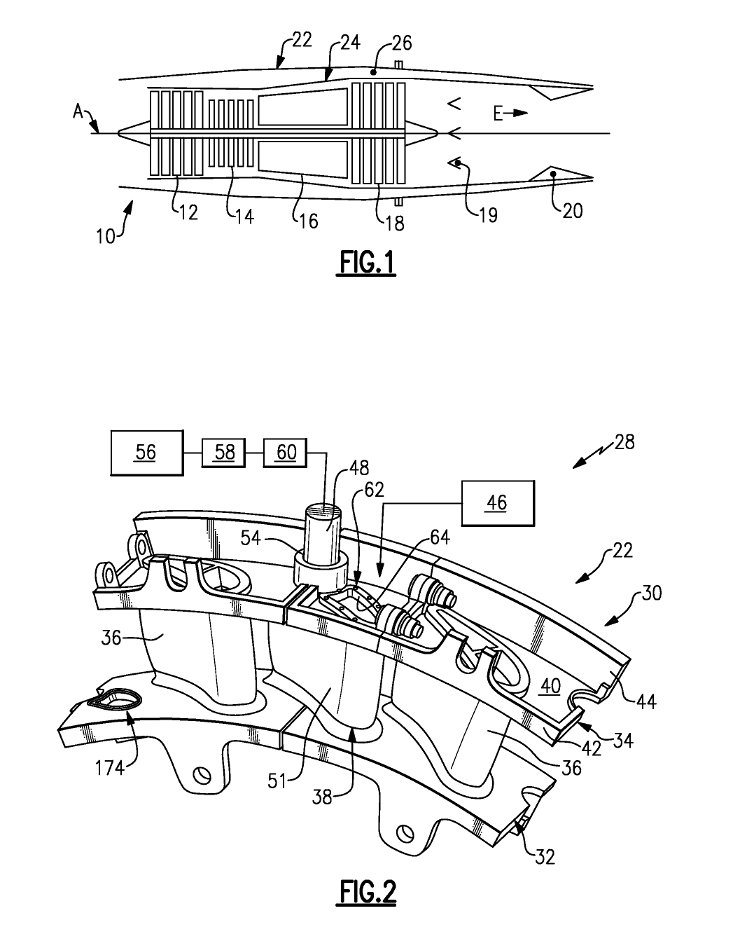

FIG. 1 illustrates an example turbojet engine 10. The engine 10 generally includes a fan section 12, a compressor section 14, a combustor section 16, a turbine section 18, an augmentor section 19 and a nozzle section 20. The compressor section 14, combustor section 16 and turbine section 18 are generally referred to as the core engine. An axis A of the engine 10 is generally disposed and extends longitudinally through the sections. An outer engine duct structure 22 and an inner cooling liner structure 24 provide an annular secondary fan bypass flow path 26 around a primary exhaust flow path E.

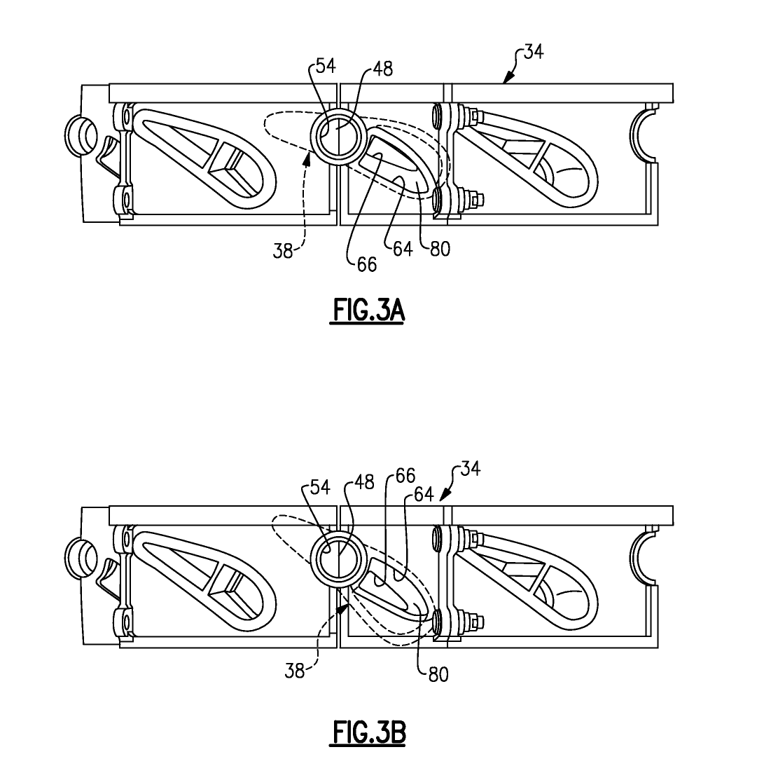

FIG. 2 illustrates a portion of a variable stator vane stage 28, which is provided in the turbine section 14, for example. It should be understood that the disclosed variable stator vane can be used in the fan or compressor sections, if desired. The disclosed variable stator vane arrangement can be applied to turbojets, low bypass turbofans, high bypass turbofans, geared turbofans, two spool engines, three spool engines, augmented engines, and/or engines with one or more bypass streams.

A case 30 supports an array of circumferentially arranged fixed and adjustable stator vanes 36, 38 extending between radially spaced apart inner and outer platforms 32, 34. The outer platform 34 includes a circumferential channel 40 arranged between forward and aft rails 42, 44. A cooling source 46 is in fluid communication with the channel 40 to supply cooling fluid to the fixed and adjustable vanes 36, 38.

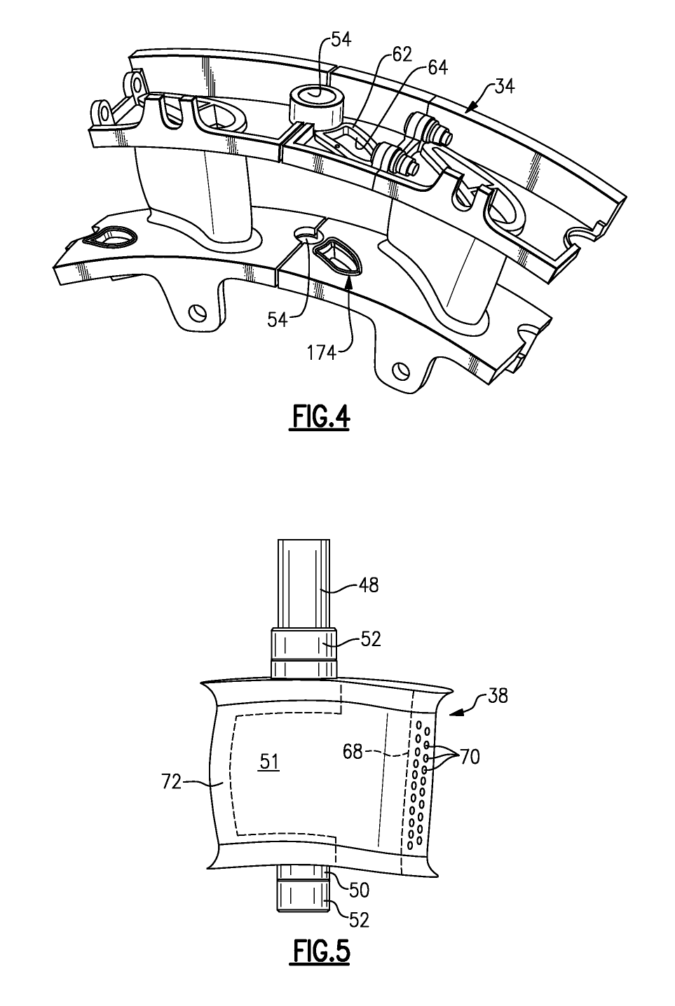

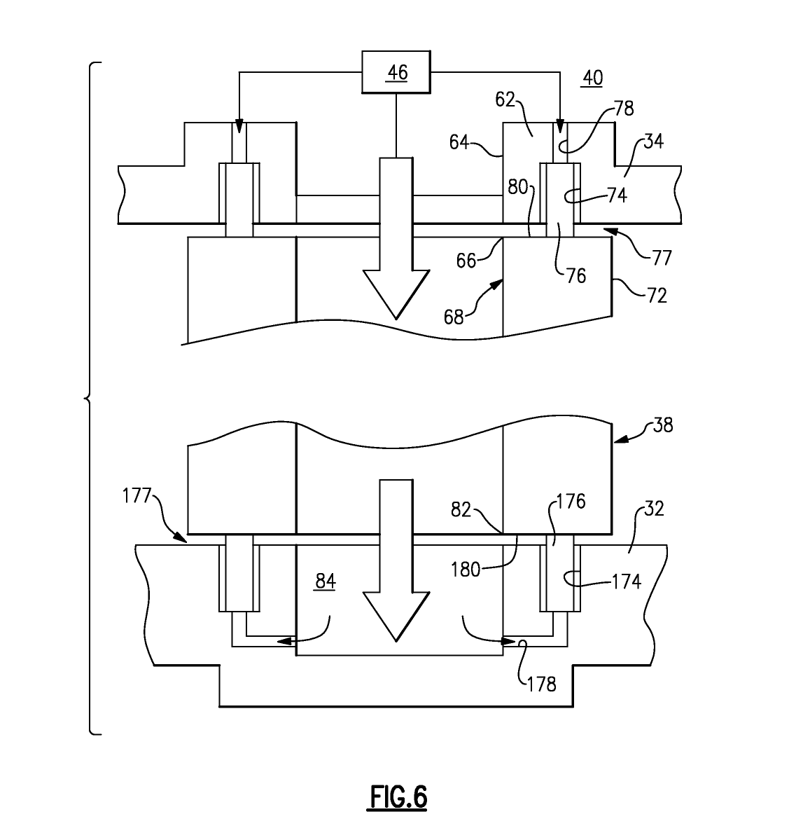

The adjustable vane 38 includes outer and inner trunnions 48, 50 (FIG. 5) each received in a corresponding hole 54 in the inner and outer platforms 32, 34, as best shown in FIG. 4. Each trunion 48, 50 may have a bushing or a bearing between it and the inner and outer platforms 32, 34.

Returning to FIG. 2, a controller 56 commands an actuator 58 connected to a linkage 60 that is coupled to the outer trunnion 48. The actuator rotates the airfoil 51 of the adjustable vane 38 between fully closed and fully opened positions, shown in FIGS. 3A and 3B, respectively, to control the flow of fluid through the engine's core flow path.

Cooling fluid is communicated from the cooling source 46 through an aperture 64 extending through a boss 62 in the outer platform 34, as shown in FIG. 2. The adjustable vane 38 includes an opening 66 that provides an entrance to a cooling passage 68 within the airfoil 51, shown in FIG. 5. The airfoil may include multiple film cooling holes 70 in the exterior airfoil surface 72 that are in fluid communication with the cooling passage 68. The aperture 64 is larger than the opening 66 such that when the adjustable vane 38 is moved between the fully opened and closed positions, the opening 66 remains within the aperture 64.

Referring to FIG. 6, the outer platform 34 includes a groove 74 opposite the boss 62. A seal 76 is arranged within the groove 74 and is engageable with a sealing surface 80 of the adjustable vane 38. The seal 76 circumscribes the aperture 64 and seals an end wall gap 77 provided between the sealing face 80 and the outer platform 34. Passageways 78 fluidly connect the channel 40 and the groove 74 to supply cooling fluid from the cooling source 46 to the groove 74, which energizes the seal 76 and urges the seal 76 into engagement with the sealing face 80.

Another sealing arrangement is provided at the opposing end of the vane 38. The inner platform 32 includes a recess 84 that receives the cooling fluid from an exit 82 of the cooling passage 68. A passageway 178 fluidly connects the recess 84 to a groove 174 in the inner platform 32. A seal 176 is arranged within the groove 174 and circumscribes the recess 84. The seal 176 is energized by the cooling fluid to urge the seal 176 into engagement with the sealing face 180 to seal the end wall gap 177.

The disclosed sealing arrangement enables cooling fluid to be efficiently communicated to the adjustable vane while minimizing leakage of the cooling air. Transferring the cooling fluid to the adjustable vane at an area adjacent to the trunnion rather than through the trunnion enables an efficient and simple sealing arrangement with a feed area that is not limited by the trunion geometry.

It should also be understood that although a particular component arrangement is disclosed in the illustrated embodiment, other arrangements will benefit herefrom.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A gas turbine engine with an adjustable vane, comprising:
a platform with a hole and an aperture; and
a vane is supported for rotation relative to the platform by a trunion received in the hole, the vane has an opening laterally spaced from the trunion and in alignment with the aperture, the vane includes an airfoil with a cooling passage in fluid communication with the opening.

2. The gas turbine engine according to claim 1, wherein the platforms include an outer platform having a boss, the boss circumscribes the aperture.

3. The gas turbine engine according to claim 2, wherein the outer platform includes a groove opposite the boss adjacent to the vane, and a seal is provided in the groove and is engageable with the vane.

4. The gas turbine engine according to claim 3, comprising a cooling source in fluid communication with the outer platform, a passageway extending through the boss to the groove and configured to supply fluid from the cooling source to the seal to urge the seal into engagement with the vane.

5. The gas turbine engine according to claim 3, wherein the aperture is larger than the opening, the seal circumscribes the aperture.

6. The gas turbine engine according to claim 5, wherein the vane is moveable between fully opened and closed positions, the vane opening remaining within the seal boundary in the fully opened and closed positions.

7. The gas turbine engine according to claim 1, wherein the opening is an entrance, and the cooling passage includes an exit opposite the entrance, the platform includes an inner platform having a recess in fluid communication with the exit.

8. The gas turbine engine according to claim 7, wherein the inner platform includes a groove opposite the vane, and a seal is provided in the groove and is engageable with the vane.

9. The gas turbine engine according to claim 8, comprising a cooling source in fluid communication with the outer platform, a passageway extending through the boss to the groove and configured to supply fluid from the cooling source to the seal to urge the seal into engagement with the vane.

10. The gas turbine engine according to claim 8, wherein the aperture is larger than the opening, the seal circumscribes the aperture, the vane is moveable between fully opened and closed positions, the vane opening remaining within the seal boundary in the fully opened and closed positions.

11. The gas turbine engine according to claim 1, comprising a turbine section, the vane arranged within the turbine section.

12. The gas turbine engine according to claim 11, comprising a circumferential array of fixed and adjustable vanes.

13. An adjustable vane for a gas turbine engine, comprising:
an airfoil arranged between opposing trunions extending from opposing sealing faces, and an opening in one of the sealing faces laterally spaced from one of the trunions, the airfoil has a cooling passage in fluid communication with the opening.

14. The adjustable vane according to claim 13, wherein an opening is provided on each of the sealing faces.

15. The adjustable vane according to claim 13, wherein the trunions are not in fluid communication with the cooling passage.

16. The adjustable vane according to claim 13, comprising bushings or bearings supported on each of the trunions.

17. A method of cooling an adjustable vane for a gas turbine engine, comprising:
supporting a vane for rotation relative to a platform about a trunion; and
energizing a seal provided between the platforms and the vane to seal a gap between the platforms and the vane.

18. The method according to claim 17, comprising the step of supplying cooling fluid to the vane from an area adjacent to the trunion.

19. The method according to claim 18, wherein the platform includes an inner platform and an outer platform, and comprising the step of energizing a seal provided between at least one of the outer and inner platforms and the vane and engaging the vane with the seal.

20. The method according to claim 17, wherein the supplying step includes providing a cooling fluid to the interior of the vane.
